(19) United States
(12) Patent Application Publication
(10) Pub. No.: US 2010/0206327 A1
(43) Pub. Date: Aug. 19, 2010

(54) Composition

(76) Inventors: Giuseppe DiBono, Mira (IT); Gayle Kennedy, Montvale, NJ (US); Mattia DeDominicis, Johannesburg (ZA); Alessandro Cagnina, Mira (IT)

Correspondence Address: PARFOMAK, ANDREW N.;NORRIS MCLAUGHLIN & MARCUS PA, 875 THIRD AVE, 8TH FLOOR, NEW YORK, NY, 10022, US

(21) Appl. No.: 12/593,358

(22) PCT Filed: Mar. 31, 2008
(86) PCT No.: PCT/GB08/01145

§ 371 Date: Mar. 16, 2010

(30) Foreign Application Priority Data
Mar. 31, 2007 (GB) 0706343.1

(51) Int. Cl. A47L 13/10; B08B 7/00

(52) U.S. Cl. 134/6; 15/209.1; 15/104.93

(57) ABSTRACT

A laminated wipe comprises an absorbent layer, an upper impermeable layer and a lower permeable layer.

This invention relates to cleaning wipe.

Cleaning wipes are commonly available. They are typically used for cleaning hard surfaces, e.g. kitchen/bathroom floors and work surfaces and also for textile surfaces such as clothing/fabric. The cleaning wipes may be impregnated with a cleaning formulation or may consist entirely of an absorbent material.

Wipes currently available cause several problems for consumers in use. Many of the problems are connected with the materials of the wipe.

For wipes commonly cellulose based materials are used. These materials are acceptable in that they provide a fair level of absorbency at low cost. However, at their typical thickness cellulose based wipes can suffer from integrity issues, especially when being rubbed vigorously on a surface, particularly a rough surface such as a carpet.

Also, whilst it has been found to be possible to impregnate a cellulose wipe with a cleaning formulation, the use of cellulose materials present a number of limitations in both the amount and nature of the material being used. In this regard although cellulose has a high level of absorbency of standard (e.g. aqueous) cleaning compositions, it only permits a low level of the absorbed cleaning formulation to be released from the wipe. This can lead to poor treatment of stains on two counts; firstly because only a small (insufficient) amount of cleaning agent can be applied to the stain and secondly because when the stain has been treated the absorption of the treated stain is often incomplete [since the cellulose is still at least partially loaded with the non-released cleaning composition] with the disadvantage that the residue from the “treated” stain is smeared over the area being cleaned. Synthetic wipes also suffer from these disadvantages.

Furthermore cellulose does not exhibit a high level of stability against some of the agents used in cleaning formulations, particularly bleaches such as peroxide (e.g. hydrogen peroxide) based bleaches. Moreover even when the cellulose wipe has been impregnated with a detergent formulation, which is potentially harmful for a user, it does not offer any protection for the user against the formulation. This means that care must be taken and, for example, protective clothing must be used.

It is an object of the present invention to obviate/mitigate the disadvantages described above.

According to a first aspect of the present invention, there is provided a laminated wipe comprising an absorbent layer, an upper impermeable layer and a lower permeable layer.

Generally the absorption layer is a micro-fibre. Suitable materials for use in the micro-fibre include poly-propylene.

Here it has been found that the use of a micro-fibre material, particularly a polypropylene micro-fibre material is advantageous. It is theorised that this is due to the way in which the micro-fibre material is able to absorb a fluid. This absorption is believed to be purely physical in nature such that an absorbed fluid is absorbed into the pores within the micro-fibre. This kind of absorption is advantageous in that there is no interaction between the micro-fibre material and the fluid being absorbed, with the effects that a very high proportion (e.g. almost 100%) of the absorbed material can be removed from the micro-fibre easily, e.g. by physical interaction.

This also means that the soiled cleaning formulation can be highly effectively withdrawn back into the absorbent layer (without fear of re-deposition, and connected problems such as spreading) layer since it has a high level or absorbency. It is further postulated that the presence of the lower permeable layer also aids the absorption process.

Usually the lower layer is a non-woven web. Preferably the non-woven web comprises an inert material such as a plastics composition. This reduces the amount of detrimental interaction between the absorbed fluid and the micro-fibre. Suitable materials for use in the lower layer include polypropylene.

Non-woven webs for the lower layer (particularly non-woven webs comprising hydrophobic materials such as poly-propylene) have been found to be ideally suited to this purpose. It is contemplated that these advantageous properties are connected with the hydrophobic nature of the web comprising material. Here it is thought that as the web comprises a hydrophobic material and since most cleaning formulations/stain are hydrophilic (e.g. aqueous) in nature the web provides a barrier to transport of the cleaning formulations/stain across the web, meaning that the cleaning formulations/stain cannot pass through the web without some form of physical influence being applied to the web.

In practice this has the effect that before use the amount of cleaning formulation which can be retained by the wipe is enhanced by the use of a hydrophobic lower web. This means that stains can be treated highly effectively by a relatively high amount of cleaning formulation that can be retained in the wipe before use. Additionally the use of a hydrophobic lower web has the effect that the re-deposition of “soiled” cleaning formation composition (i.e. the cleaning formulation composition after it has been allowed to contact a stain and has been absorbed back into the wipe) is minimised. This effect is highly advantageous as often stains involve highly disagreeable materials which are problematic because of their colour, smell or microbial content. Clearly anything which aids their removable from the area being treated and obviates their re-deposition/distribution is therefore highly advantageous.

In certain applications (e.g. for cleaning some hard surfaces) the lower layer may be modified such that it is made abrasive.

Generally the upper layer comprises impermeable layer of polyethylene.

With such a layer the wipe is extremely “user-friendly” in that a user is able to employ the wipe in a cleaning operation without being brought into contact with the cleaning formulation or with components of the stain

Commonly the absorption layer contains a detergent composition. The absorption layer preferably contains around 20-800 g, more preferably 50-750 g, more preferably 100-750 g, and most preferably 300-750 g detergent composition per square metre.

The exact nature of the detergent cleaning composition will vary depending upon the intended end use of the wipe. However, usually the detergent composition comprises an admixture of one or more of the following components; surfactant (anionic, cationic, zwitterionic, non-ionic), bleach, bleach activator, solvent, enzyme, dye, preservative, builder, fragrance, thickener, pH adjusting agent, anti-microbial agent.

Generally the detergent composition is a liquid. Generally the composition is free of suspended particles.

A preferred example of a carpet cleaning formulation is below:—

| Formula | % |
|---|---|
| Alcohol Ethoxylate 7EO | 2.000 |
| Iminodisuccinate | 0.612 |
| Glycolether PPH | 0.700 |
| Glycolether DPnP | 7.500 |
| Fragrance | 0.100 |
| Citric Acid | 0.440 |
| Hydrogen Peroxide | 1.500 |
| Water | 86.608 |
| Acrylate Copolymer | 0.540 |

A preferred example of a hard surface cleaning formulation is below:—

| Formula | % |
|---|---|
| Lauryldimethaminoxide | 1.05 |
| Monoethanolamine | 0.75 |
| Propylene glycol | 0.80 |
| phenyl ether | |
| Fragrance | 0.20 |
| DI Water | 97.200 |

Generally the wipe itself has a density of 10-500 g per square metre, more preferably 100-400 g per square metre.

Of that the upper layer is preferably 10-200 g/m². The absorption layer is preferably 10-400 g/m². The lower layer is preferably 10-200 g/m².

Generally the wipe is in the form of a simple planar sheet.

In an alternative embodiment the wipe is in the form of a glove, intended to be fitted onto/over a hand of a user. In this case preferably the wipe is constructed such that it has an additional sheet of material attached thereto [to the upper impermeable layer], wherein between the wipe and the additional sheet there is a space to accommodate a user's hand. The space may be tailored such that it has finger spaces to fit a hand.

In a yet further alternative the wipe may have an associated handle to facilitate gripping by a user. In this case suitable forms of the handle include a band of material attached to two or more points of the wipe [to the upper impermeable layer], wherein between the wipe and the band there is a space to accommodate a user's hand or a portion of a hand.

The additional sheet/handle may be attached to the wipe by any common attachment method such as by glue, welding or by being sewn to the wipe.

The additional sheet/handle preferably comprises an inert material such as a polyolefin, e.g. polyethylene.

According to a second aspect of the invention there is provided the use of a laminated wipe in accordance with the first aspect of the invention for treating a stain on a surface.

The stain treatment method may involve a mechanical action provided by a user, such as a wiping or scrubbing motion. Such methods are particularly suitable for “instant” stain treatment, where the user addresses and completely removes a stain in a single operation.

As stated above it has been found that the wipe according to the first aspect of the invention has excellent cleaning formulation absorbency, so much so that a cleaning formulation may not be released from the wipe unless some sort of mechanical agitation (e.g. twisting or application of pressure) is applied. In this way the wipe affords a different method of stain treatment which involves the application/release of pressure. In this way a user may apply pressure to an upper surface of the wipe, when the wipe is located upon a stain to be treated. By doing so the wipe is able to release a cleaning formulation onto the stain. Then in a second step as the applied pressure is removed/reduced the wipe is able to draw the cleaning formulation (and the treated stain) back into itself. This operation may be repeated a number of times until the stain has been completely addressed. In this regard it has been found that the lower non-woven layer acts as a highly effective filter: allowing non-contaminated detergent formulation to leave the wipe and contact the stain but not permitting any/only permitting a very small portion of the stain to be re-deposited from the wipe onto the area being treated. This is particularly true of greasy stains such as motor oil.

The wipe may be left on the surface being treated. In this way the user may be freed up to attend to other household duties whilst the stain is being ameliorated.

The wipe can have a two-fold action in this regard. Firstly the wipe is able to provide a moisture barrier to the upper surface of the satin. This is important in that such a barrier prevents drying/oxidation or other action which, if untreated, normally allow the stain to become more difficult to remove or causes irreparable dame to the surface being treated. Secondly, a small amount of cleaning formulation can be mechanically removed from the wipe so that the cleaning operation can begin without the user the present.

It is envisaged that the wipe could be left on a stain to be treated for a period of from 2-24 hours before the user has to return top the stain and complete the cleaning operation.

Generally the wipe is for use in cleaning fibrous surfaces, such as a carpet or an item of clothing.

Alternatively the wipe is for use in cleaning a hard surface such as a kitchen work surface or hard floor (e.g. a wooden/ceramic/plastic) floor.

Generally the wipe is used by being manually grasped by a user and applied to the surface being addressed. It is also possible that the wipe may be used with an implement, and retained on same. Suitable implements include mops, preferably mops which retain the wipe in a flat orientation.

The invention is now illustrated by reference to the following non-limiting examples.

### EXAMPLES

### Example 1

### Pre-Treatment Test Results

A performance test was conducted under realistic staining conditions.

The test was conducted using standard soils on a carpet sample [15 cm×15 cm] and the following wipes:—

### Pretreater—Smooth:

Carpet cleaning formulation [from page 5]: 670 g/m²

Wipe Composition: a) Upper Layer: Polyethylene Film, 18 g/m²; b) Absorbent Layer: Polypropylene Microfiber, 200 g/m²; c) Lower Layer: Polypropylene Nonwoven, 15 g/m².

### Pretreater—Abrasive:

Carpet cleaning formulation [from page 5]: 670 g/m²

Wipe Composition: a) Upper Layer: Polyethylene Film, 18 g/m²; b) Absorbent Layer: Polypropylene Microfiber, 200 g/m²; c) Lower Layer: Polypropylene Nonwoven with abrasive particles, 20 g/m²

### Testing Protocol:

i) Apply the stain and, for pretreated stains, wait 1 min before pretreatment to allow the stain to set into the carpet;
ii) Pretreat with the wipe blotting 4 times, 2 sec per blot;
iii) Allow stains (both pretreated and untreated references) to age 24 hours, leaving the wipe on the stain for pretreated stains;
iv) After 24 hours, remove wipes and clean both treated and reference (not pretreated) stains with 15 g of a household carpet cleaner [Resolve Triple Action], blotting each stain 30 times with a honeycomb tissue;
v) Wait for further 24 hours, then measure stain intensity. ΔE indicates the level of stain still present on the carpet. The lower the ΔE, the better the cleaning.

The results are summarized in the table below [each FIGURE is a ΔE]:

| | Red | | | |
|---|---|---|---|---|
| | Wine | Juice | Coffee | Tomato |
| No Pretreatment | 17.70 | 9.39 | 10.66 | 14.77 |
| Smooth | 9.04 | 7.79 | 7.66 | 10.36 |
| Abrasive | 8.90 | 7.25 | 7.81 | 7.71 |

Each of the stain treatment results was much better than the non pre-treated test.

### Example 2

### Stain Treatment with Wipe Test Results

A performance test was conducted under realistic staining conditions.

The test was conducted using standard soils on a carpet sample [15 cm×15 cm] and the wipes from Example 1.

### Testing Protocol (Wipe):

i) Apply the stains and allow them to age 24 hours;
ii) Wipe the stain 10 times up and down and 10 times side to side;
iii) Wait for further 24 hours, then measure % of soil removal (ΔL). ΔL indicates by how much the soil was removed from the carpet. The higher the ΔL, the better the removal.

### Testing Protocol (Non-Wipe):

i) Apply the stains and allow them to age 24 hours;
ii) Apply 5 g of a household carpet cleaner [Resolve Triple Action:], then blot 30 times with a honeycomb tissue;
iii) Wait for further 24 hours, then measure % of soil removal (ΔL). ΔL indicates by how much the soil was removed from the carpet. The higher the ΔL, the better the removal.

The results are summarized in the table below [each FIGURE is a ΔL]:

| | | Grape | | | | Food |
|---|---|---|---|---|---|---|
| | Red Wine | Juice | Coffee | Tomato | DMO | Grease |
| RESOLVE | 84.44 | 82.99 | 79.11 | 61.03 | 38.58 | 50.08 |
| Smooth | 87.20 | 82.62 | 88.26 | 62.36 | 47.99 | 68.77 |
| Abrasive | 92.15 | 83.04 | 88.96 | 70.76 | 50.09 | 75.76 |

Each of the stain treatment results was much better with the wipe than with the household carpet cleaner.

1. A laminated wipe comprising an absorbent layer, an upper impermeable layer and a lower permeable layer.

2. A laminated wipe comprising an absorbent layer and a lower permeable layer.

3. A laminated wipe according to claim 1, wherein the absorbent layer comprises a micro-fibre.

4. A laminated wipe according to claim 3, wherein the absorbent layer comprises a polypropylene micro-fibre.

5. A laminated wipe according to claim 2, wherein the lower permeable layer comprises a non-woven web.

6. A laminated wipe according to claim 5, wherein the lower permeable layer comprises an abrasive component.

7. A laminated wipe according to claim 1, wherein the upper impermeable layer is an impermeable layer of polyethylene.

8. A laminated wipe according to claim 2, wherein the absorbent layer contains a detergent composition.

9. A laminated wipe according to claim 8, wherein the detergent composition is a liquid.

10. A laminated wipe according to claim 8, wherein the detergent composition is a carpet cleaning formulation.

11. A laminated wipe according to claim 8, wherein the detergent composition is a surface cleaning formulation.

12. A laminated wipe according to claim 8, wherein the absorption layer contains around 20-800 g detergent per square metre.

13. A laminated wipe according to claim 1, wherein the laminated wipe has a density of 10-500 g per square metre.

14. A method of treating a stain on a surface, comprising the step of: contacting a laminated wipe according to claim 1 with the stain on the surface.

15. The method according to claim 14 wherein a liquid is released from the laminated wipe by application of pressure onto the laminated wipe.

16. The method according to claim 14, wherein the laminated wipe is left on the surface for a period of up to around 24 hours in order to ensure that water absorption has occurred.

17. The method according to claim 14, wherein the surface is a fibrous surface.

18. The method according to claim 14, wherein the surface is a hard surface.

19. The method according to claim 17 wherein the fibrous surfaces is a carpet or an item of clothing.

20. The method according to claim 18 wherein the hard surface is a kitchen work surface.
